(19) United States
(12) Patent Application Publication
(10) Pub. No.: US 2006/0092186 A1
(43) Pub. Date: May 4, 2006

(54) Liquid crystal display device

(75) Inventors: Toshiaki Yoshihara, Kawasaki (JP); Tetsuya Makino, Kawasaki (JP); Shinji Tadaki, Kawasaki (JP); Hironori Shiroto, Kawasaki (JP); Yoshinori Kiyota, Kawasaki (JP); Shigeo Kasahara, Kawasaki (JP); Keiichi Betsui, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/296,048

(22) Filed: Dec. 7, 2005

Related U.S. Application Data
(63) Continuation of application No. PCT/JP03/09893, filed on Aug. 4, 2003.

(51) Int. Cl. G09G 5/10

(52) U.S. Cl. 345/690

(57) ABSTRACT

A color display is performed by carrying out a switching between a first driving system in which the OFF timing of a light source and the end timing of a data scanning agree with each other and a second driving system in which the OFF timing of a light source and the end timing of a data scanning do not agree with each other. In case where a response time of a liquid crystal from a transmission state to a light-shielding state is sufficiently short, a color display is performed by using the first driving system to decrease a light-emitting time of a light source. On the other hand, in case where the response time of the liquid crystal from the transmission state to the light-shielding state is increased, a color display is performed by using the second driving system.

This application is a continuation of PCT International Application No. PCT/JP2003/009893 which has an International filing date of Aug. 4, 2003, which designated the United States of America.

### TECHNICAL FIELD

The present invention relates to field-sequential type or color-filter type liquid crystal display devices.

### BACKGROUND ART

Along with the recent development of so-called information-oriented society, electronic apparatuses, such as personal computers and PDA (Personal Digital Assistants), have been widely used. With the spread of such electronic apparatuses, portable apparatuses that can be used in offices as well as outdoors have been used, and there are demands for small-size and light-weight of these apparatuses. Liquid crystal display devices are widely used as one of the means to satisfy such demands. Liquid crystal display devices not only achieve small size and light weight, but also include an indispensable technique in an attempt to achieve low power consumption in portable electronic apparatuses that are driven by batteries.

The liquid crystal display devices are mainly classified into the reflection type and the transmission type. In the reflection type liquid crystal display devices, light rays incident from the front face of a liquid crystal panel are reflected by the rear face of the liquid crystal panel, and an image is visualized by the reflected light; whereas in the transmission type liquid crystal display devices, the image is visualized by the transmitted light from a light source (backlight) placed on the rear face of the liquid crystal panel. Since the reflection type liquid crystal display devices have poor visibility because the reflected light amount varies depending upon environmental conditions, transmission type color liquid crystal display devices using color filters are generally used as display devices of personal computers for displaying multi-color or full-color images.

As the color liquid crystal display devices, TN (Twisted Nematic) type using switching elements such as a TFT (Thin Film Transistor) are widely used. Although the TFT-driven TN type liquid crystal display devices have better display quality, compared to STN (Super Twisted Nematic) type liquid crystal display devices, they require a backlight with high brightness to achieve high screen brightness because the light transmittance of the liquid crystal panel is only four percent or so at present. For this reason, a lot of power is consumed by the backlight. Moreover, since a color display is achieved using color filters, a single pixel needs to be composed of three sub-pixels, and there are problems that it is difficult to provide a high-resolution display, and the purity of the displayed colors is not sufficient.

In order to solve such problems, the present inventors have developed field-sequential type liquid crystal display devices, (see, for example, T. Yoshihara, et. al., ILCC 98, P1-074, 1998; T. Yoshihara, et. al., AM-LCD '99 Digest of Technical Papers, p. 185, 1999; and T. Yoshihara, et. al., SID '00 Digest of Technical Papers, p. 1176, 2000). Such field-sequential type liquid crystal display devices do not require sub-pixels, and therefore, displays with higher resolution can be easily realized compared to color-filter type liquid crystal display devices. Moreover, since a field-sequential type liquid crystal display device can use the color of light emitted by the light source as it is for display without using a color filter, the displayed color has excellent purity. Furthermore, since the light utilization efficiency is high, a field-sequential type liquid crystal display device has the advantage of low power consumption. However, in order to realize a field-sequential type liquid crystal display device, high-speed responsiveness (2 ms or less) of liquid crystal is essential.

In order to provide a field-sequential type liquid crystal display device with significant advantages as mentioned above or increase the speed of response of a color-filter type liquid crystal display device, the present inventors are conducting research and development on the driving of liquid crystals such as a ferroelectric liquid crystal having spontaneous polarization, which may achieve 100 to 1000 times faster response compared to a prior art, by a switching element such as a TFT (for example, Japanese Patent Application Laid-Open No. 11-119189/1999). In the ferroelectric liquid crystal, the long-axis direction of the liquid crystal molecules tilts with the application of voltage. A liquid crystal panel sandwiching the ferroelectric liquid crystal therein is sandwiched by two polarization plates whose polarization axes are orthogonal to each other, and the intensity of the transmitted light is changed using birefringence caused by the change in the long-axis direction of the liquid crystal molecules. For such a liquid crystal display device, a ferroelectric liquid crystal having half-V-shaped electro-optic response characteristics with respect to the applied voltage is generally used as a liquid crystal material.

FIG. 1 shows an example of the drive sequence for a conventional field-sequential type liquid crystal display device, wherein FIG. 1(a) shows the scanning timing of each line of the liquid crystal panel, and FIG. 1(b) shows the ON timing of red, green and blue of the backlight. One frame is divided into three sub-frames, and, for example, as shown in FIG. 1(b), red light is emitted in the first sub-frame, green light is emitted in the second sub-frame, and blue light is emitted in the third sub-frame.

Meanwhile, as shown in FIG. 1(a), for the liquid crystal panel, two times of image data writing scanning are performed within a sub-frame of each of red, green and blue. In the first data writing scanning, data writing scanning is performed with a polarity capable of realizing a bright display. In the second data writing scanning, a voltage having a polarity opposite to that in the first data writing scanning and substantially equal magnitude is applied. Consequently, a darker display can be realized compared to the first data writing scanning, and the display is recognized as a substantially “black image”.

It is effective from the viewpoint of light utilization efficiency and power consumption that, instead of turning on the backlight (light source) all the time in the sub-frame, the backlight (light source) is turned off in synchronism with the end timing of the second data scanning, thereby matching the OFF timing of the backlight (light source) to the end timing of the second data scanning.

However, in case where the OFF timing of the light source is made synchronism with the end timing of the second data scanning, a deterioration in responsiveness is caused due to a temperature fall in a liquid crystal display device using a liquid crystal material having spontaneous polarization, such as a ferroelectric liquid crystal or antiferroelectric liquid crystal having excellent responsiveness, thereby entailing a problem of high possibility of causing a display unevenness from the beginning region (upstream) of the data scanning to the last region (downstream) thereof. The problem of the display unevenness is true not only for a field-sequential type liquid crystal display device but also for a color-filter type liquid crystal display device.

### DISCLOSURE OF THE INVENTION

The present invention has been made with the aim of solving the above problems, and it is an object of the present invention to provide a liquid crystal display device capable of reducing power consumption without causing display unevenness.

A liquid crystal display device according to a first aspect of the present invention is a field-sequential type liquid crystal display device that performs a color display, for every sub-frame obtained by dividing one frame so as to correspond to each of plural colors, by synchronizing a sequential switching of the light of each of the plural colors incident on a liquid crystal display element from a light source with a data scanning for the liquid crystal display element based upon display data of each color, wherein an OFF timing of the light source is placed between the end timing of the data scanning and the end timing of the sub-frame corresponding to the data scanning.

In the field-sequential type liquid crystal display device according to the first aspect, the OFF timing of the light source for sequentially changing the color of the emitted light for every sub-frame does not agree with the end timing of the data scanning, but it is present between the end timing of the data scanning and the end timing of the sub-frame corresponding to the data scanning. Specifically, the light source is turned off during from a time that is after a while from the end of the data scanning before the next sub-frame.

A liquid crystal display device according to a fourth aspect of the present invention is a color-filter type liquid crystal display device that performs a color display, for every frame, by synchronizing an incidence of white light to a liquid crystal display element, provided with color filters of plural colors, due to a turning-on or turning-off control of a light source with a data scanning for the liquid crystal display element based upon display data, wherein an OFF timing of the light source does not agree with the end timing of the data scanning, but is placed between the end timing of the data scanning and the end timing of the frame corresponding to the data scanning.

In the color-filter type liquid crystal display device according to the fourth aspect, the OFF timing of the light source in each frame does not agree with the end timing of the data scanning, but it is present between the end timing of the data scanning and the end timing of the frame corresponding to the data scanning. Specifically, the light source is turned off during from a time that is after a while from the end of the data scanning before the next frame.

When the OFF timing of the light source is made simultaneously with the end timing of the data scanning for the liquid crystal display element in case where the response time of the liquid crystal from the transmission state to the light-shielding state is increased, brightness rise is generated according to the increased response time of the liquid crystal from the transmission state to the light-shielding state at the upstream of the data scanning, since there is a predetermined time from the data scanning to the turn-off of the light source. On the other hand, at the downstream of the data scanning, the brightness rise due to the increased response time of the liquid crystal from the transmission state to the light-shielding state is not caused, since the time from the data scanning to the turn-off of the light source is short. Accordingly, a display unevenness is caused when the OFF timing of the light source is made simultaneously with the end timing of the data scanning for the liquid crystal display element in case where the response time of the liquid crystal from the transmission state to the light-shielding state is increased. In view of this, if the response time from the transmission state to the light-shielding state of the liquid crystal is increased, the brightness rises, according to the increased response time, at the upstream and downstream of the data scanning are made equal to each other, thereby being capable of solving this display unevenness.

In the first and fourth aspects, the OFF timing of the light source does not agree with the end timing of the data scanning, but a predetermined time is provided from the end of the data scanning to the turn-off of the light source, whereby the display unevenness in the data scanning from the upstream toward the downstream is reduced. Further, in the first aspect, the light source is turned off before the end of the sub-frame, so that the deterioration in the displayed color due to the color mixture is not caused.

A liquid crystal display device according to a second aspect of the present invention is a field-sequential type liquid crystal display device that performs a color display, for every sub-frame obtained by dividing one frame so as to correspond to each of plural colors, by synchronizing a sequential switching of the light of each of the plural colors incident on the liquid crystal display element from a light source with a data scanning for the liquid crystal display element based upon display data of each color, wherein a color display is performed by a switching between a first driving system in which the OFF timing of the light source and the end timing of the data scanning agree with each other and a second driving system in which the OFF timing of the light source and the end timing of the data scanning do not agree with each other.

The field-sequential type liquid crystal display device according to the second aspect has the first driving system in which the OFF timing of the light source and the end timing of the data scanning agree with each other in each sub-frame, and the second driving system in which the OFF timing of the light source and the end timing of the data scanning do not agree with each other in each sub-frame. This device switches both systems, thereby performing a color display.

A liquid crystal display device according to a fifth aspect of the present invention is a color-filter type liquid crystal display device that performs a color display, for every frame, by synchronizing an incidence of white light to a liquid crystal display element, provided with color filters of plural colors, due to a turning-on or turning-off control of a light source with a data scanning for the liquid crystal display element based upon display data, wherein a color display is performed by a switching between a first driving system in which the OFF timing of the light source and the end timing of the data scanning agree with each other and a second driving system in which the OFF timing of the light source and the end timing of the data scanning do not agree with each other.

The color-filter type liquid crystal display device according to the fifth aspect has the first driving system in which the OFF timing of the light source and the end timing of the data scanning agree with each other in each frame, and the second driving system in which the OFF timing of the light source and the end timing of the data scanning do not agree with each other in each frame. This device switches both systems, thereby performing a color display.

In the second and fifth aspects, the color display is performed by using the first driving system (in which the OFF timing of the light source and the end timing of the data scanning agree with each other) to decrease the light-emitting time of the light source, in case where the response time of the liquid crystal from the transmission state to the light-shielding state is sufficiently short, thereby attempting to reduce power consumption. On the other hand, in case where the response time of the liquid crystal from the transmission state to the light-shielding state is increased, the color display is performed by using the second driving system (in which the OFF timing of the light source and the end timing of the data scanning do not agree with each other) to switch the OFF timing of the light source to the timing considering the responsiveness of the liquid crystal, thereby reducing the display unevenness from the upstream toward the downstream of the data scanning.

A liquid crystal display device according to a third aspect of the present invention is that, in the second aspect, the OFF timing of the light source is placed between the end timing of the data scanning and the end timing of the sub-frame corresponding to the data scanning in the second driving system.

In the field-sequential type liquid crystal display device according to the third aspect, the OFF timing of the light source at each sub-frame in the second driving system is provided between the end timing of the data scanning and the end timing of the sub-frame corresponding to the data scanning.

A liquid crystal display device according to a sixth aspect of the present invention is that, in the fifth aspect, the OFF timing of the light source is placed between the end timing of the data scanning and the end timing of the frame corresponding to the data scanning in the second driving system.

In the color-filter type liquid crystal display device according to the sixth aspect, the OFF timing of the light source at each frame in the second driving system is provided between the end timing of the data scanning and the end timing of the frame corresponding to the data scanning.

In the third and sixth aspects, the light source is turned off during from the time that is after a while after the data scanning is ended to the time before the next sub-frame or next frame, whereby the display unevenness is surely prevented by providing a predetermined time from the end of the data scanning to the turn-off of the light source. Further, in the third aspect, the light source is turned off before the end of the sub-frame, so that light sources of different colors are not simultaneously turned on, and hence, the deterioration in the displayed color due to a color mixture is not caused.

A liquid crystal display device according to a seventh aspect of the present invention comprises, in the second, third, fifth or sixth aspect, measuring means for measuring a temperature of the liquid crystal display element and means for controlling the switching between the first driving system and the second driving system according to the measured result of the measuring means.

In the liquid crystal display device according to the seventh aspect, the switching between the first driving system and the second driving system is controlled according to the temperature of the liquid crystal display element. Accordingly, the display unevenness brought with the deterioration in the responsiveness of the liquid crystal caused by a low-temperature environment can simply be reduced.

A liquid crystal display device according to an eighth aspect of the present invention comprises, in the second, third, fifth or sixth aspect, means for controlling the switching between the first driving system and the second driving system according to the response characteristic of the liquid crystal display element.

In the liquid crystal display device according to the eighth aspect, the switching between the first driving system and the second driving system is controlled according to the responsiveness of the liquid crystal. Accordingly, the display unevenness brought with the deterioration in the responsiveness of the liquid crystal can surely be reduced.

### BRIEF DESCRIPTION OF THE DRAWINGS

FIG. 1 is an illustration showing a drive sequence for a liquid crystal display device of a conventional example;

FIG. 2 is a block diagram showing one example of a circuit structure of a liquid crystal display device according to the present invention (first embodiment);

FIG. 3 is a schematic cross sectional view of the liquid crystal panel and backlight of a field-sequential type liquid crystal display device;

FIG. 4 is a schematic view showing an example of the overall structure of the liquid crystal display device according to the present invention;

FIG. 5 is an illustration showing a drive sequence (first driving system) for a field-sequential type liquid crystal display device according to the present invention;

FIG. 6 is an illustration showing a drive sequence (second driving system) for a field-sequential type liquid crystal display device according to the present invention;

FIG. 7 is a graph showing a temperature dependency of a response time of a liquid crystal display element from a transmission state to a light-shielding state;

FIG. 8 is a graph showing an electro-optic response characteristics of a liquid crystal material used for a liquid crystal display device of the present invention;

FIG. 9 is a block diagram showing one example of a circuit structure of a liquid crystal display device according to the present invention (second embodiment);

FIG. 10 is a schematic cross sectional view of a liquid crystal panel and backlight of a color-filter type liquid crystal display device;

FIG. 11 is an illustration showing one example of a drive sequence in a color-filter type liquid crystal display device according to the present invention; and

FIG. 12 is an illustration showing another example of a drive sequence in a color-filter type liquid crystal display device according to the present invention.

### BEST MODE FOR IMPLEMENTING THE INVENTION

The following description will specifically explain the present invention with reference to the drawings illustrating some embodiments thereof. Note that the present invention is not limited to the following embodiments.

### FIRST EMBODIMENT

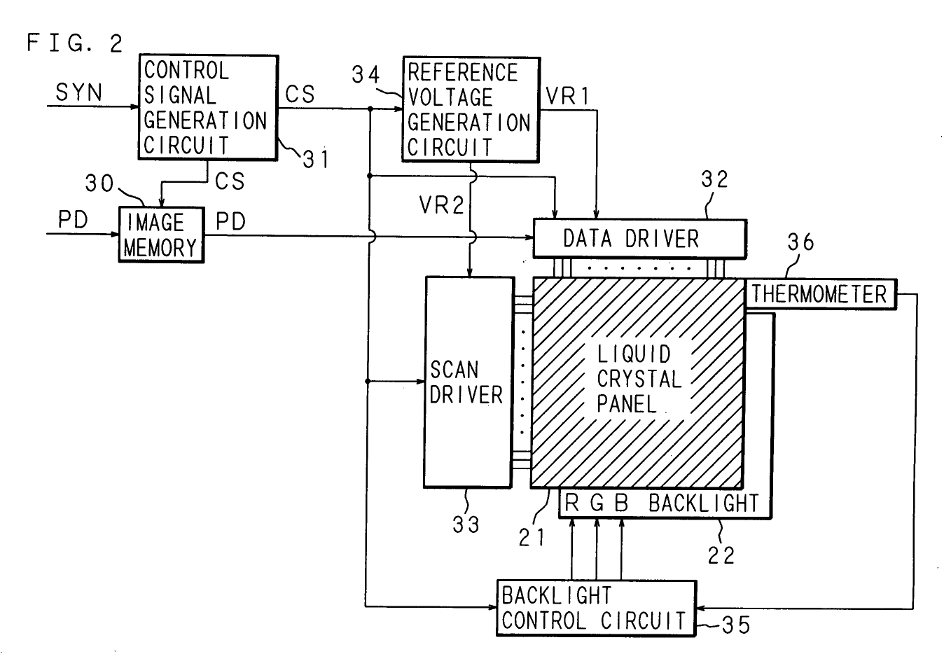

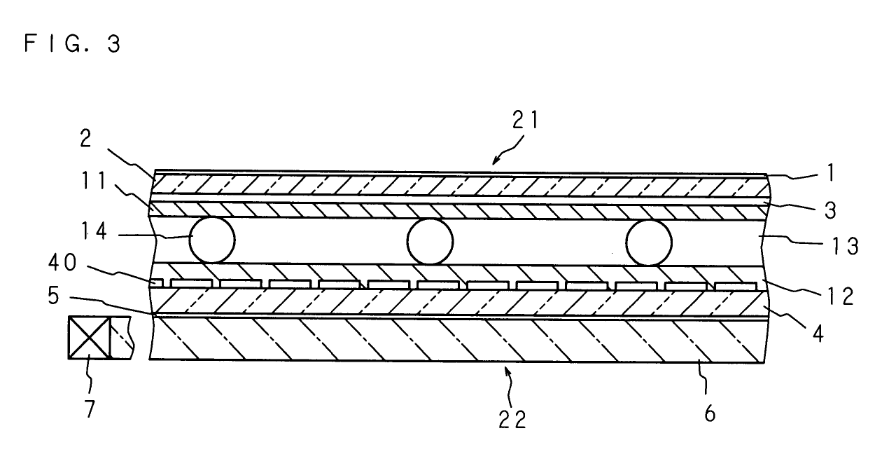

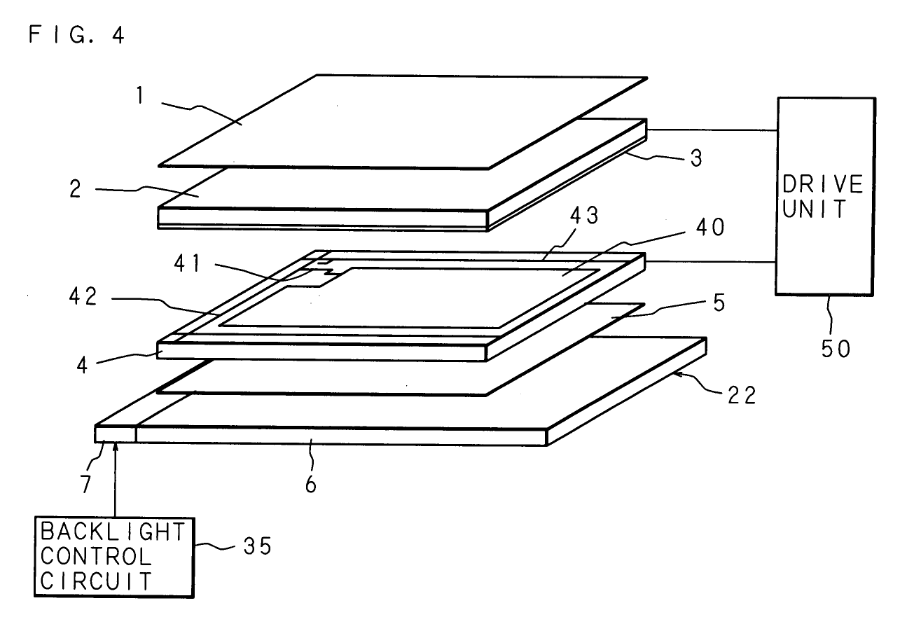

FIG. 2 is a block diagram showing the circuit structure of a liquid crystal display device according to the first embodiment of the present invention; FIG. 3 is a schematic cross sectional view of a liquid crystal panel and a backlight; and FIG. 4 is a schematic view showing an example of the overall structure of the liquid crystal display device.

In FIG. 2, the numerals 21 and 22 represent a liquid crystal panel and a backlight whose cross sectional structures are shown in FIG. 3. The backlight 22 is composed of an LED array 7 and a light guiding/diffusing plate 6. As shown in FIGS. 3 and 4, the liquid crystal panel 21 comprises a polarization film 1, a glass substrate 2, a common electrode 3, a glass substrate 4 and a polarization film 5, which are stacked in this order from the upper layer (front face) side to the lower layer (rear face) side, and pixel electrodes 40 which are arranged in matrix form on the common electrode 3 side of the glass substrate 4.

A drive unit 50 comprising a data driver 32 and a scan driver 33 is connected between the common electrode 3 and the pixel electrodes 40. The data driver 32 is connected to TFTs 41 through signal lines 42, while the scan driver 33 is connected to the TFTs 41 through scanning lines 43. The TFTs 41 are controlled to be on/off by the scan driver 33. Moreover, each of the pixel electrodes 40 is connected to the TFT 41. Therefore, the intensity of transmitted light of each individual pixel is controlled by a signal given from the data driver 32 through the signal line 42 and the TFT 41.

An alignment film 12 is provided on the upper face of the pixel electrode 40 on the glass substrate 4, while an alignment film 11 is placed on the lower face of the common electrode 3. The space between these alignment films 11 and 12 is filled with a liquid crystal material so as to form a liquid crystal layer 13. Note that the numeral 14 represents spacers for maintaining a layer thickness of the liquid crystal layer 13.

The backlight 22 is disposed on the lower layer (rear face) side of the liquid crystal panel 21, and has the LED array 7 placed to face an end face of the light guiding/diffusing plate 6 that forms a light emitting area. This LED array 7 comprises ten LEDs, one LED chip being composed of LED elements that emit light of the three primary colors, namely red (R), green (G) and blue (B), on a face facing the light guiding/diffusing plate 6. The LED array 7 turns on the red, green and blue LED elements in red, green and blue sub-frames, respectively. The light guiding/diffusing plate 6 guides the light emitted from each LED of this LED array 7 to its entire surface, and diffuses the light to the upper face, thereby functioning as the light emitting area.

This liquid crystal panel 21 and the backlight 22 capable of emitting red, green and blue light in a time-divided manner are stacked one upon another. The ON timing and the color of emitted light of the backlight 22 are controlled in synchronism with data writing scanning of the liquid crystal panel 21 based on display data.

In FIG. 2, the numeral 31 is a control signal generation circuit to which a synchronous signal SYN is inputted from a personal computer, and which generates various control signals CS necessary for display. Pixel data PD is outputted from an image memory 30 to the data driver 32. Based on the pixel data PD and a control signal CS for changing the polarity of applied voltage, a voltage is applied to the liquid crystal panel 21 through the data driver 32 upon plural times of data writing scanning.

Moreover, the control signal generation circuit 31 outputs a control signal CS to each of a reference voltage generation circuit 34, the data driver 32, the scan driver 33, and a backlight control circuit 35. The reference voltage generation circuit 34 generates reference voltages VR1 and VR2, and outputs the generated reference voltages VR1 and VR2 to the data driver 32 and the scan driver 33, respectively. The data driver 32 outputs signals to the signal lines 42 of the pixel electrodes 40, based on the pixel data PD from the image memory 30 and the control signals CS from the control signal generation circuit 31. In synchronism with the output of the signals, the scan driver 33 scans the scanning lines 43 of the pixel electrodes 40 sequentially on a line by line basis. Further, the backlight control circuit 35 applies a drive voltage to the backlight 22 so as to emit red light, green light, and blue light from the backlight 22.

Further, numeral 36 represents a thermometer for measuring a temperature of the liquid crystal panel 21. The thermometer 36 outputs the measured temperature of the liquid crystal panel 21 to the backlight control circuit 35. The backlight control circuit 35 has a first driving system and a second driving system, wherein either one of the first driving system and the second driving system is selected according to the temperature of the liquid crystal panel 21 measured by the thermometer 36. Specifically, in case where the temperature of the liquid crystal panel 21 is higher than −5° C., the driving system is changed to the first driving system, while in case where it is not more than −5° C., the driving system is changed to the second driving system.

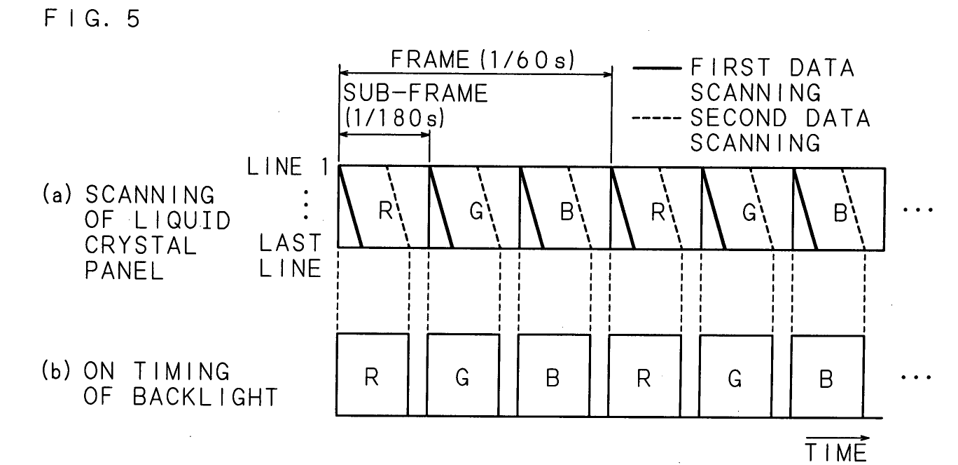

The first driving system is the one in which the OFF timing of the backlight 22 (LED elements of each color) and the end timing of the data scanning agree with each other. FIG. 5 shows the drive sequence in the first driving system, wherein FIG. 5(a) shows the scanning timing of each line of the liquid crystal panel 21, and FIG. 5(b) shows the ON timing of red, green and blue of the backlight 22. One frame (period: 1/60 s) is divided into three sub-frames (period: 1/180 s), and red light is emitted in the first sub-frame, green light is emitted in the second sub-frame, and blue light is emitted in the third sub-frame. Meanwhile, for the liquid crystal panel 21, two times of image data writing scanning are performed within a sub-frame of each of red, green and blue. In the first data scanning, data writing scanning is performed with a polarity capable of realizing a bright display. In the second data scanning, a voltage having a polarity opposite to that in the first data writing scanning and substantially equal magnitude is applied. Consequently, a darker display can be realized compared to the first data scanning, and the display is recognized as a substantially “black image”. Then, the backlight 22 is turned off in synchronism with the end timing of the second data scanning in each sub-frame.

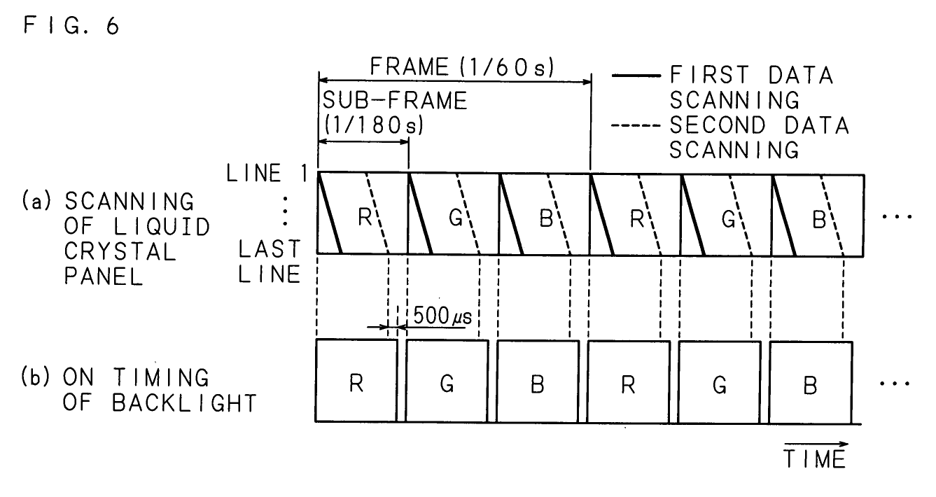

The second driving system is the one in which the OFF timing of the backlight 22 (LED elements of each color) and the end timing of the data scanning do not agree with each other. FIG. 6 shows the drive sequence in the second driving system, wherein FIG. 6(a) shows the scanning timing of each line of the liquid crystal panel 21, and FIG. 6(b) shows the ON timing of red, green and blue of the backlight. The OFF timing of the backlight 22 is not synchronism with the end timing of the second data scanning, but shifted after the end timing of the second data scanning by 500 μs. It should be noted that the OFF timing of the backlight 22 is before the end timing of the sub-frame. As a result, the OFF timing of the backlight 22 is placed between the end timing of the second data scanning and the end timing of the sub-frame corresponding to this data scanning.

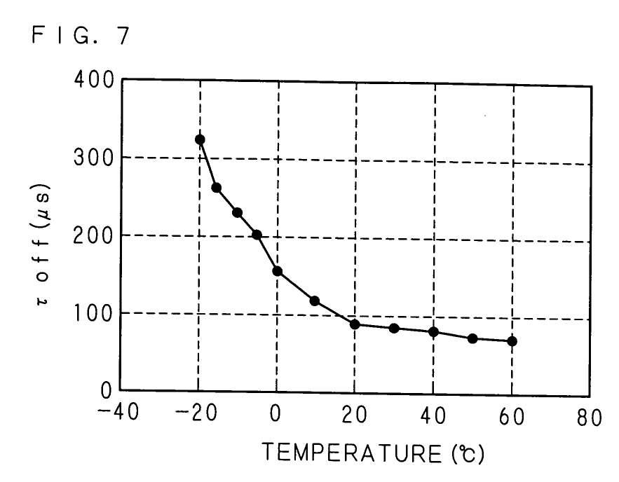

FIG. 7 is a graph showing a temperature dependency of a response time of the liquid crystal display element from the transmission state to the light-shielding state. In FIG. 7, axis of abscissa represents the temperature (° C.) of the liquid crystal display element while axis of ordinate represents the response time (τ off: μs). As the temperature of the liquid crystal display element lowers, the response time is increased. For example, the response time is 200 μs at −5° C. In the second driving system, the time between the end timing of the second data scanning and the OFF timing of the backlight 22 is set to 500 μs that is sufficiently longer than 200 μs. Accordingly, the driving system is changed to the second driving system, in case where the temperature is not more than −5° C., thereby being capable of reducing luminance unevenness.

Next, the operation of the liquid crystal display device according to the present invention will be explained. Pixel data PD for display is inputted to the image memory 30 from the personal computer. After storing the pixel data PD temporarily, the image memory 30 outputs the pixel data PD upon receipt of the control signal CS outputted from the control signal generation circuit 31. The control signal CS generated by the control signal generation circuit 31 is supplied to the data driver 32, scan driver 33, reference voltage generation circuit 34, and backlight control circuit 35. The reference voltage generation circuit 34 generates reference voltages VR1 and VR2 upon receipt of the control signal CS, and outputs the generated reference voltages VR1 and VR2 to the data driver 32 and the scan driver 33, respectively.

When the data driver 32 receives the control signal CS, it outputs a signal to the signal lines 42 of the pixel electrodes 40, based on the pixel data PD outputted from the image memory 30. When the scan driver 33 receives the control signal CS, it scans the scanning lines 43 of the pixel electrodes 40 sequentially on a line by line basis. According to the output of the signal from the data driver 32 and the scanning by the scan driver 33, the TFTs 41 are driven, and a voltage is applied to the pixel electrodes 40, thereby controlling the intensity of the transmitted light of the pixels.

When the backlight control circuit 35 receives the control signal CS, it applies a drive voltage to the backlight 22 so as to cause the red, green and blue LED elements of the LED array 7 of the backlight 22 to emit light in a time-divided manner, thereby emitting red light, green light, and blue light sequentially with passage of time. At this time, the measured temperature of the liquid crystal panel 21 is inputted to the backlight control circuit 35 from the thermometer 36, whereby the backlight 22 (LED elements of each color) is turned off in accordance with the drive sequence given by either one of the first driving system (see FIG. 5) and the second driving system (see FIG. 6).

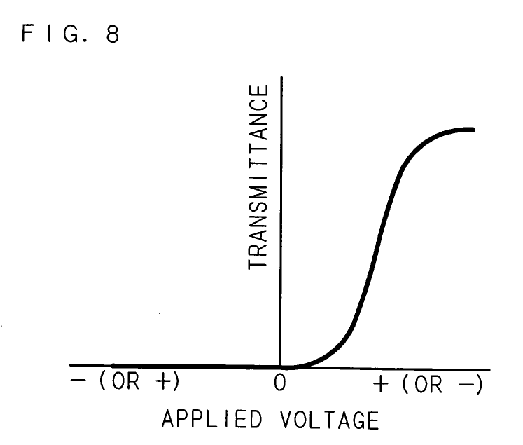

A specific example will be explained hereinafter. After washing a TFT substrate having pixel electrodes 40 (pixel number: 640×480, diagonal: 3.2 inches) and a glass substrate 2 having a common electrode 3, they were coated with polyimide and baked for one hour at 200° C. so as to form about 200 Å thick polyimide films as alignment films 11 and 12. Further, these alignment films 11 and 12 were rubbed with a rayon fabric, and an empty panel was produced by stacking these two substrates so that the rubbing directions are parallel and maintaining a gap therebetween by spacers 14 made of silica having an average particle size of 1.8 μm. A ferroelectric liquid crystal material having half-V-shaped electro-optic response characteristics as shown in FIG. 8 was sealed between the alignment films 11 and 12 of this empty panel so as to form a liquid crystal layer 13. The magnitude of spontaneous polarization of the sealed ferroelectric liquid crystal material was 8 nC/cm². The maximum value of the angle made by the average molecular axis of the liquid crystal molecule in the absence of the applied voltage and the average molecular axis of the liquid crystal molecule in the presence of the applied voltage is 30° at one side. The liquid crystal panel 21 was produced by sandwiching the fabricated panel by two polarization films 1 and 5 arranged in a crossed-Nicol state, and a dark state is provided when the voltage is not applied.

The liquid crystal panel 21 thus fabricated and the backlight 22 comprising the LED array 7 capable of switching surface emission of monochrome colors, red, green and blue, as a light source, were stacked one upon another, and a color display was performed by a field-sequential method, by performing a switching between the drive sequence given by the first driving system shown in FIG. 5 or the drive sequence given by the second driving system shown in FIG. 6 according to the temperature of the liquid crystal panel 21.

As a result, a uniform display can be realized with reduced power consumption in the room temperature environment around 25° C., and further, a uniform display can also be realized at the temperature environment under −5° C.

Although the delay time of the OFF timing of the backlight 22 in the second driving system is set to one kind that is 500 μs in the aforesaid example, plural kinds of delay times are set beforehand based upon the characteristics shown in the graph of FIG. 7, whereby the color display may be performed in accordance with the drive sequence by any of the delay times that are changeable according to the temperature of the liquid crystal panel 21.

### SECOND EMBODIMENT

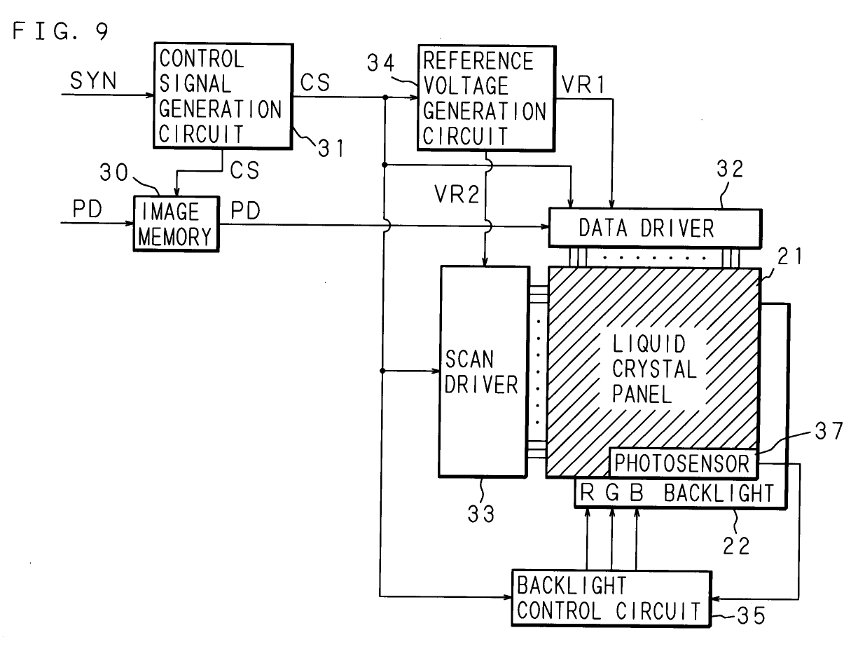

FIG. 9 is a block diagram showing the circuit structure of a liquid crystal display device according to the second embodiment. In FIG. 9, the same parts as in FIG. 2 are designated with the same numerals, and the explanation thereof is omitted.

In the aforesaid first embodiment, the switching of the drive sequence is made in accordance with the temperature of the liquid crystal panel 21. However, in this second embodiment, the switching of the drive sequence is made in accordance with the response time from the transmission state to the light-shielding state of the liquid crystal panel 21.

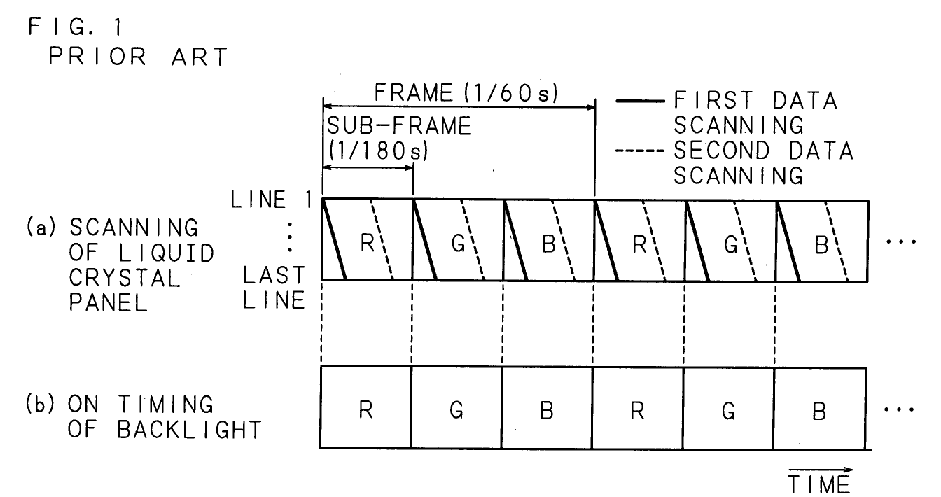

In FIG. 9, numeral 37 represents a photosensor provided to the liquid crystal panel 21. The photosensor 37 detects the response time from the transmission state to the light-shielding state of the liquid crystal panel 21, and outputs the detected result to the backlight control circuit 35. Specifically, the drive sequence (all turned on during sub-frame) shown in FIG. 1 is set at a predetermined interval (for example, interval of 30 s), and the response time from the transmission state to the light-shielding state of the liquid crystal panel 21 at this point is detected by the photosensor 37. Then, the time from the end timing of the data scanning to the OFF timing of the backlight 22 is adjusted by the backlight control circuit 35 according to the detected response time.

Notably, the other configurations and operations are same as those explained in the aforesaid first embodiment, so that the explanation thereof is omitted.

The specific example will be explained hereinafter. The liquid crystal panel 21 fabricated in the same manner as in the first embodiment and the backlight 22 comprising the LED array 7 capable of switching surface emission of monochrome colors, red, green and blue, as a light source, were stacked one upon another, and a color display was performed by a field-sequential method, while adjusting the time from the end timing of the data scanning to the OFF timing of the backlight 22 according to the detected result of the response time by the photosensor 37 from the transmission state to the light-shielding state of the liquid crystal panel 21.

As a result, the time from the end timing of the data scanning to the OFF timing of the backlight 22 can minutely be adjusted, thereby being capable of always realizing uniform color display within the operation range.

### COMPARATIVE EXAMPLE

A liquid crystal panel fabricated in the same manner as in the first embodiment and a backlight comprising the LED array 7 capable of switching surface emission of monochrome colors, red, green and blue, as a light source, were stacked one upon another, and a color display was performed by a field-sequential method in accordance with the drive sequence shown in FIG. 5, regardless of the temperature of the liquid crystal panel.

As a result, the display unevenness at the upstream and downstream of the data scanning is remarkable in the temperature environment under −5° C.

It should be noted that, in the above-mentioned example, the LED light source is used as the light source, but it is not limited to the LED light source, so long as it is a light source such as EL (Electronic Luminescence), cold cathode tube, or the like. Further, a transmission-type liquid crystal display element is used, but a reflection-type liquid crystal display element may be used.

In the above-mentioned embodiments, the field-sequential type liquid crystal display devices are explained as examples, but the same effects can also be obtained for color-filter type liquid crystal display devices having color filters. The reason for this is that the present invention can be implemented similarly by applying the drive sequence for a sub-frame of the field-sequential method to a frame of the color-filter method.

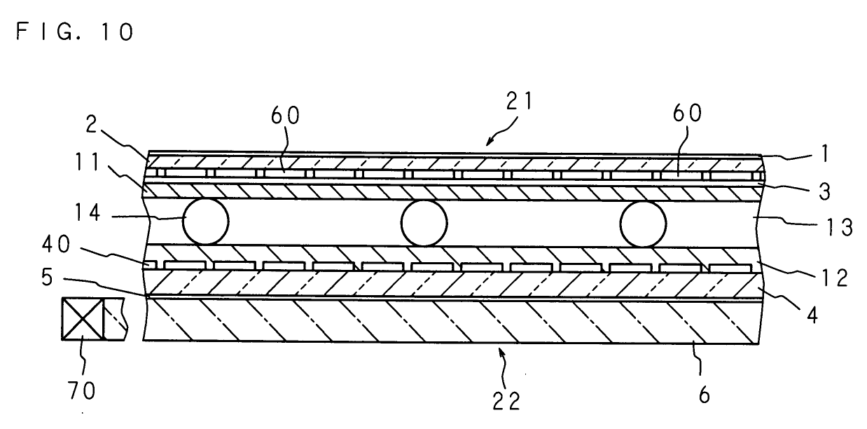

FIG. 10 is a schematic cross sectional view of the liquid crystal panel and backlight of a color-filter type liquid crystal display device. In FIG. 10, the same parts as in FIG. 3 are designated with the same numerals, and the explanation thereof is omitted. The common electrode 3 is provided with color filters 60 of the three primary colors (R, G, B). Besides, the backlight 22 is composed of a white light source 70 comprising one or more of white light source elements for emitting white light, and a light guiding/diffusing plate 6. In such a color-filter type liquid crystal display device, a color display is performed by selectively transmitting white light emitted from the white light source 70 through the color filters 60 of a plurality of colors.

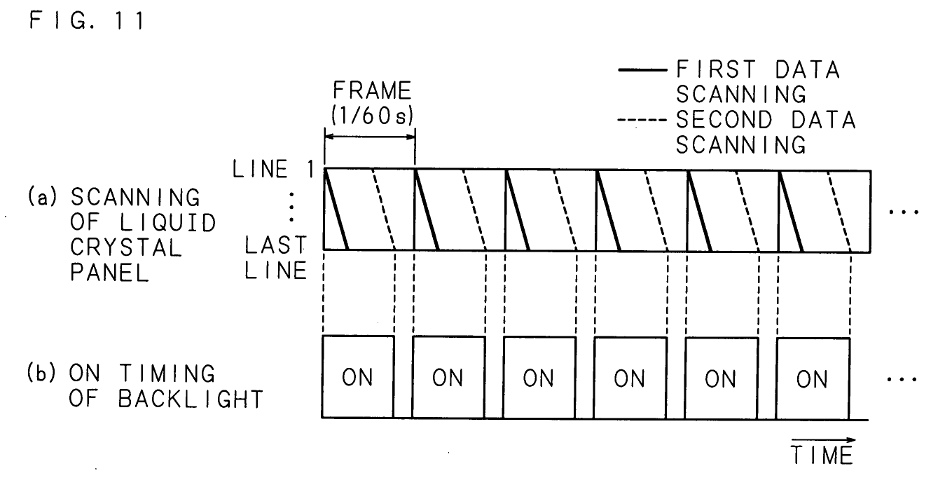

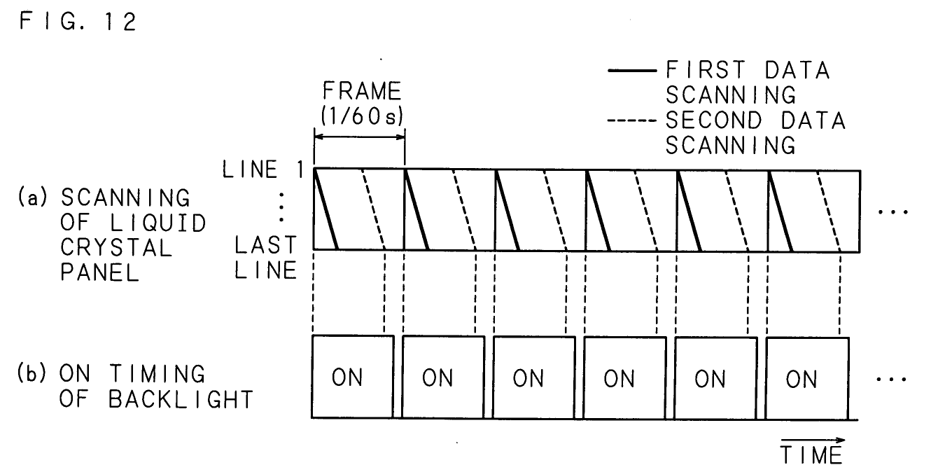

Further, even in the color-filter type liquid crystal display device, similarly to the above-mentioned field-sequential type liquid crystal display devices, it is possible to provide the effects of reducing the display unevenness and reducing power consumption by obtaining the temperature or response characteristics (response time of the liquid crystal panel from the transmission state to the light-shielding state) and performing a switching between the drive sequence (the OFF timing of the backlight 22 (white light source 70) and the end timing of the data scanning agree with each other) shown in FIG. 11 and the drive sequence (the OFF timing of the backlight 22 (white light source 70) and the end timing of the data scanning do not agree with each other) shown in FIG. 12 in accordance with the obtained temperature or response characteristics.

### INDUSTRICAL APPLICABILITY

As explained above in detail, the present invention is configured such that the OFF timing of a light source does not agree with the end timing of a data scanning, but is placed between the end timing of a data scanning and the end timing of a sub-frame corresponding to the data scanning, thereby being capable of reducing display unevenness from the upstream to the downstream of the data scanning. Further, in a field-sequential type, a deterioration of a displayed color due to a color mixture can be prevented.

Moreover, the present invention is configured such that a color display is performed by carrying out a switching between a first driving system wherein the OFF timing of a light source and the end timing of a data scanning agree with each other and a second driving system wherein the OFF timing of a light source and the end timing of a data scanning do not agree with each other. Therefore, in case where a response time of a liquid crystal from a transmission state to a light-shielding state is sufficiently short, the color display is performed by using the first driving system to decrease a light-emitting time of a light source, thereby attempting to reduce power consumption. On the other hand, in case where the response time of the liquid crystal from the transmission state to the light-shielding state is increased, the color display is performed by using the second driving system, whereby display unevenness from the upstream to the downstream of the data scanning is reduced by switching the OFF timing of the light source to the OFF timing of the light source considering the responsiveness of the liquid crystal. Accordingly, the display unevenness can be reduced, and further, power consumption can be reduced.

1. A field-sequential type liquid crystal display device which performs a color display, for every sub-frame obtained by dividing one frame so as to correspond to each of plural colors, by synchronizing a sequential switching of a light of each of the plural colors incident on a liquid crystal display element from a light source with a data scanning for the liquid crystal display element based upon display data of each color,
wherein an OFF timing of the light source is placed between an end timing of the data scanning and an end timing of the sub-frame corresponding to the data scanning.

2. A field-sequential type liquid crystal display device which performs a color display, for every sub-frame obtained by dividing one frame so as to correspond to each of plural colors, by synchronizing a sequential switching of a light of each of the plural colors incident on a liquid crystal display element from a light source with a data scanning for the liquid crystal display element based upon display data of each color,
wherein a color display is performed by a switching between a first driving system in which an OFF timing of the light source and an end timing of the data scanning agree with each other and a second driving system in which an OFF timing of the light source and an end timing of the data scanning do not agree with each other.

3. The liquid crystal display device according to claim 2, comprising
a measuring unit for measuring a temperature of the liquid crystal display element; and
a control unit for controlling the switching between the first driving system and the second driving system according to a measured result of the measuring unit.

4-5. (canceled)

6. The liquid crystal display device according to claim 5, comprising
a measuring unit for measuring a temperature of the liquid crystal display element; and
a control unit for controlling the switching between the first driving system and the second driving system according to a measured result of the measuring unit.

7. The liquid crystal display device according to claim 5, comprising
a control unit for controlling the switching between the first driving system and the second driving system according to a response characteristic of the liquid crystal display element.

8. (canceled)

9. A color-filter type liquid crystal display device which performs a color display, for every frame, by synchronizing an incidence of white light to a liquid crystal display element provided with color filters of plural colors due to a turning-on or turning-off control of a light source with a data scanning for the liquid crystal display element based upon display data,
wherein an OFF timing of the light source is placed between an end timing of the data scanning and an end timing of a frame corresponding to the data scanning.

10. A color-filter type liquid crystal display device which performs a color display, for every frame, by synchronizing an incidence of white light to a liquid crystal display element provided with color filters of plural colors due to a turning-on or turning-off control of a light source with a data scanning for the liquid crystal display element based upon display data,
wherein a color display is performed by a switching between a first driving system in which an OFF timing of the light source and an end timing of the data scanning agree with each other and a second driving system in which an OFF timing of the light source and an end timing of the data scanning do not agree with each other.

11. The liquid crystal display device according to claim 10, comprising
a measuring unit for measuring a temperature of the liquid crystal display element; and
a control unit for controlling the switching between the first driving system and the second driving system according to a measured result of the measuring unit.

12. The liquid crystal display device according to claim 10, comprising
a control unit for controlling the switching between the first driving system and the second driving system according to a response characteristic of the liquid crystal display element.

13. The liquid crystal display device according to claim 10, wherein the OFF timing of the light source is placed between the end timing of the data scanning and the end timing of the frame corresponding to the data scanning in the second driving system.

14. The liquid crystal display device according to claim 13, comprising
a measuring unit for measuring a temperature of the liquid crystal display element; and
a control unit for controlling the switching between the first driving system and the second driving system according to a measured result of the measuring unit.

15. The liquid crystal display device according to claim 13, comprising
a control unit for controlling the switching between the first driving system and the second driving system according to a response characteristic of the liquid crystal display element.

16. The liquid crystal display device according to claim 2, comprising
a control unit for controlling the switching between the first driving system and the second driving system according to a response characteristic of the liquid crystal display element.

17. The liquid crystal display device according to claim 2, wherein the OFF timing of the light source is placed between the end timing of the data scanning and the end timing of the sub-frame corresponding to the data scanning in the second driving system.
